(19) United States
(12) Patent Application Publication
(10) Pub. No.: US 2026/0333511 A1
(43) Pub. Date: Oct. 22, 2026

(54) C-DRX COORDINATION FOR MUSIM UE

(71) Applicant: Apple Inc., Cupertino, CA (US)

(72) Inventors: Alexander Sirotkin, Herzliya (IL); Sudeep Manithara Vamanan, Uttenreuth, Bavaria-Bayern (DE); Fangli Xu, Beijing (CN); Yuqin Chen, Beijing (CN); Naveen Kumar R. Palle Venkata, San Diego, CA (US); Ralf Rossbach, Munich (DE); Ping-Heng Kuo, London (GB); Sethuraman Gurumoorthy, San Ramon, CA (US); Peng Cheng, Beijing (CN)

(21) Appl. No.: 19/116,758

(22) PCT Filed: Sep. 28, 2022
(86) PCT No.: PCT/CN2022/121960

§ 371 Date: Mar. 28, 2025

(51) Int. Cl. H04W 76/28; H04L 5/14; H04W 72/12; H04W 88/06

(52) U.S. Cl. CPC H04W 76/28; H04L 5/14; H04W 72/1215; H04W 88/06

(57) ABSTRACT

A user equipment (UE) includes at least one wireless transceiver and a processor. The processor is configured to determine to operate in a first C-DRX mode with a first network and to operate in a second C-DRX mode with a second network. The processor is also configured to transmit, to a first base station of the first network, via a wireless transceiver of the at least one wireless transceiver, UE assistance information that includes 1) a requested C-DRX offset for the first C-DRX mode, or 2) a C-DRX configuration of the first C-DRX mode.

### TECHNICAL FIELD

This application relates generally to a user equipment (UE) that operates in first and second connected mode discontinuous reception (C-DRX) modes with first and second networks. In some embodiments, the UE may be a multiple universal subscriber identity module (MUSIM) UE.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example of a wireless communications system that includes a UE connected to first and second networks.

FIG. 2 shows an example timeline of operations for a UE that determines to operate in a C-DRX mode with a network (e.g., a 3GPP network).

FIG. 3 shows an example timeline of operations for a UE that has determined to operate in a first C-DRX mode with a first network (e.g., a first 3GPP network) and to operate in a second C-DRX mode with a second network (e.g., a second 3GPP network or a CBRS network).

FIG. 4 shows another example timeline of operations for a UE that has determined to operate in a first C-DRX mode with a first network (e.g., a first 3GPP network) and to operate in a second C-DRX mode with a second network (e.g., a second 3GPP network or a CBRS network).

FIG. 5 illustrates an example flow diagram for configuring a C-DRX cycle.

FIG. 6 shows a first example method of wireless communication by a UE.

FIG. 7 shows a first example method of wireless communication by a base station.

FIG. 8 shows a second example method of wireless communication by a UE.

FIG. 9 shows a second example method of wireless communication by a base station.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network.

Therefore, the UE as described herein is used to represent any appropriate electronic device.

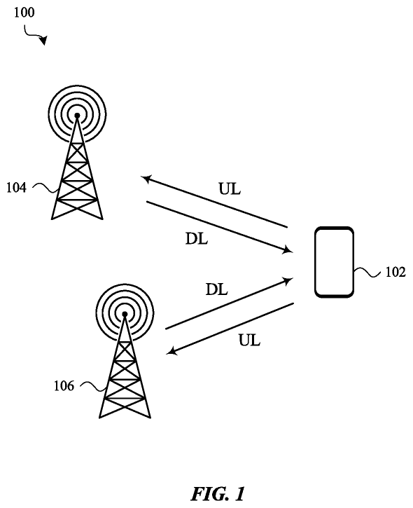

FIG. 1 shows an example wireless communications system 100. The wireless communications system includes a UE 102 that is connected to first and second networks. More particularly, the UE 102 is connected to a first base station 104 of the first network, and to a second base station 106 of the second network. The UE 102 may communicate with each of the first and second networks on an uplink (UL) and/or a downlink (DL).

In some embodiments, the UE 102 may be a MUSIM UE—i.e., a UE that includes multiple USIMs, each of which may be used to communicate over a different network (e.g., the first network or the second network). In some embodiments, the first and/or second network may be a 3GPP network. In some embodiments, one of the networks may be a Citizens Broadband Radio Service (CBRS) network.

If the UE 102 has only a single wireless transceiver (e.g., a single transmit/receive (Tx/Rx) chain), the UE 102 may communicate with the first and second networks (e.g., the first and second base stations 104, 106) at different times. If the UE 102 has two or more wireless transceivers (e.g., two or more Tx/Rx chains), the UE 102 may communicate with the first and second networks simultaneously.

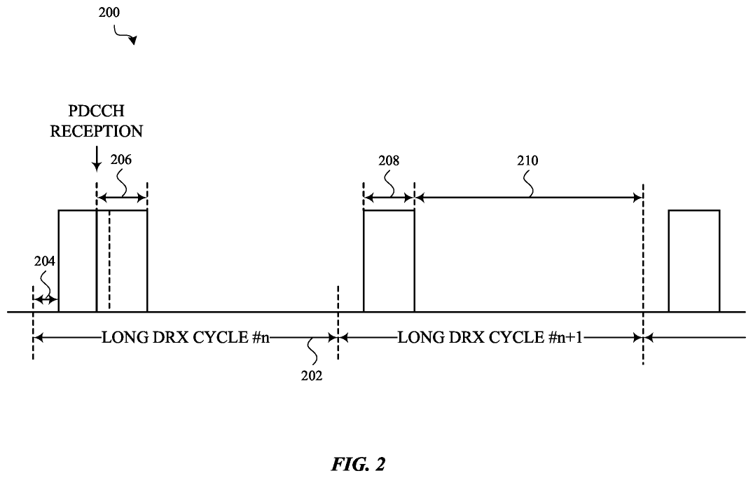

FIG. 2 shows an example timeline 200 of operations for a UE that determines to operate in a C-DRX mode with a network (e.g., a 3GPP network or a CBRS network). In some embodiments, the UE may be the UE described with reference to FIG. 1, and the network may be a network associated with one of the base stations described with reference to FIG. 1.

The UE may determine it is desirable to operate in a C-DRX mode because it is low on power (e.g., its remaining battery power is below a threshold level), because it has been placed in a low power mode by its user, or for other reasons. After determining to operate in a C-DRX mode, the UE may inform the network, and the network may use RRC signaling to indicate the parameters under which the UE may operate in a C-DRX mode. The parameters may include, for example, an indication of a long DRX cycle 202 (e.g., drx-LongCycle), a DRX slot offset 204 (e.g., drx-SlotOffset), and a DRX inactivity timer 206 (e.g., drx-InactivityTimer).

The DRX cycle 202 indicates a DRX ON duration 208 (e.g., a drx-onDurationTimer) and an optional DRX OFF duration 210 (e.g., a drx-offDurationTimer) for a long DRX cycle (e.g., Long DRX Cycle #n, Long DRX Cycle #n+1, . . . ). The DRX ON duration 208 indicates how long the UE should stay awake during each DRX cycle (e.g., to receive scheduling information or DL transmissions) before going back to sleep (e.g., entering a low power state), in the absence of identifying a PDCCH occasion in which a PDCCH indicates a subsequent arrival of a new UL or DL transmission for the UE. The DRX OFF duration 210 indicates how long the UE should sleep during each DRX cycle, if an OFF duration is not already indicated or implied. The DRX slot offset 204 indicates when the DRX ON duration 208 begins in relation to a slot boundary. The DRX inactivity timer 206 indicates how long the UE should remain awake after a PDCCH occasion in which a PDCCH indicates a new UL or DL transmission for the UE's MAC entity. If, within the duration of the DRX inactivity timer 206, the UE identifies another PDCCH occasion in which a PDCCH indicates a new UL or DL transmission for the UE's MAC entity, the DRX inactivity timer 206 may be reset and extended.

When a UE is in an RRC_CONNECTED state with each of two networks, the UE may determine it is desirable to operate in a C-DRX mode with each of the networks. For example, the UE may determine to operate in a first C-DRX mode with a first network and a second C-DRX mode with a second network. The UE may use a different USIM for each network, and may use a single or multiple wireless transceivers (or transmit/receive (Tx/Rx) chains) for communicating with each network.

After a UE determines to operate in a C-DRX mode with each of two networks (or more than two networks), it may be useful for the UE to coordinate its wake up times for its C-DRX modes with the networks. In this regard, the UE may strive for different types of coordination, depending on its configuration. For example, if the UE has only one wireless transceiver (e.g., a single Tx/Rx chain) and cannot simultaneously transmit or receive on two or more networks, the UE may strive for coordination that staggers its DRX ON times for C-DRX modes with different networks (e.g., strive for coordination that places the DRX ON times one after another or spaces them apart by a gap). In some cases, the UE may strive for DRX ON times that are adjacent or close in time, so that the UE may wake up once to satisfy both DRX ON times. If the traffic flow for one network is expected to be greater or more variable in size or duration, the UE may strive to position the DRX ON time for that network subsequent to the DRX ON time for the other network(s). If the traffic flow for both networks is expected to be greater than a threshold, the UE may strive to separate the DRX ON times for the networks by a gap, to reduce the likelihood that possible extensions of the DRX inactivity timer for one network are likely to interfere with the UE starting the DRX ON time for the other network. As another example, if the UE has two or more wireless transceivers (e.g., two or more Tx/Rx chains) and can simultaneously transmit or receive on two or more networks, the UE may strive for coordination that overlaps, and in some cases aligns, its DRX ON times for C-DRX modes with different networks. In this manner, the UE may be able to wake up, simultaneously transmit or receive on both networks, and go back to sleep, thereby conserving power.

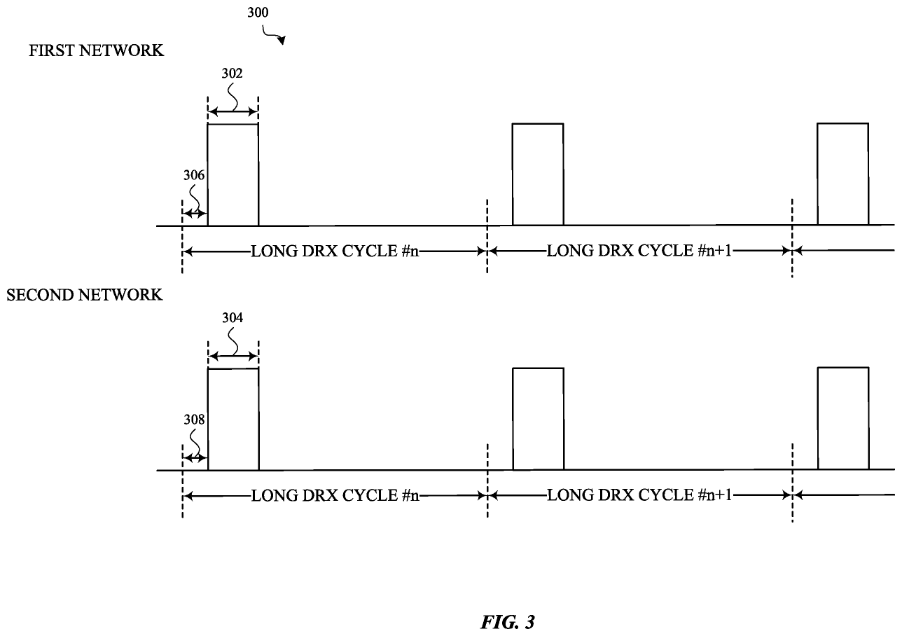

FIG. 3 shows an example timeline 300 of operations for a UE that has determined to operate in a first C-DRX mode with a first network (e.g., a first 3GPP network) and to operate in a second C-DRX mode with a second network (e.g., a second 3GPP network or a CBRS network). In some embodiments, the UE may be the UE described with reference to any of FIGS. 1-11, and the first and second networks may be networks that are respectively associated with the first and second base stations described with any of reference to FIG. 1-11. In the example illustrated in FIG. 3, the UE may have two or more wireless transceivers.

Because the UE has two or more wireless transceivers, the UE may strive to coordinate the first C-DRX mode and the second C-DRX mode so that DRX ON times 302, 304 of the first and second C-DRX modes overlap and, in some cases, are aligned. In this manner, the UE may wake up, simultaneously transmit or receive on the first and second networks, and go back to sleep while conserving the greatest amount of power. To overlap or align the DRX ON times 302, 304 of the first and second C-DRX modes, the UE may have to request a particular DRX offset adjustment 306 or 308 from one or both of the first or second networks. Currently, there is no mechanism for a UE to do this.

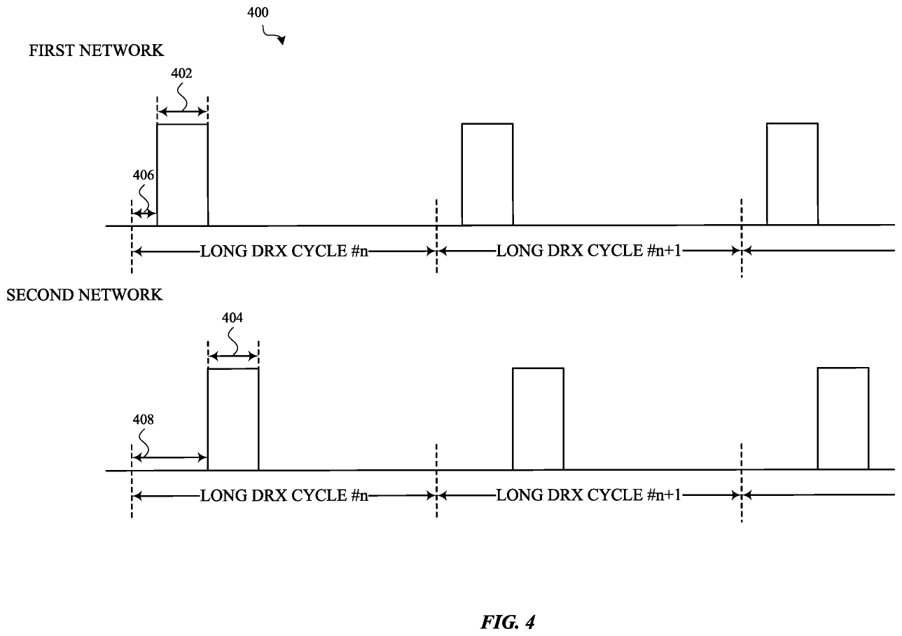

FIG. 4 shows another example timeline 400 of operations for a UE that has determined to operate in a first C-DRX mode with a first network (e.g., a first 3GPP network) and to operate in a second C-DRX mode with a second network (e.g., a second 3GPP network or a CBRS network). In some embodiments, the UE may be the UE described with reference to any of FIGS. 1-11, and the first and second networks may be networks that are respectively associated with the first and second base stations described with reference to any of FIGS. 1-11. In the example illustrated in FIG. 4, the UE may have a single wireless transceiver.

Because the UE has only one wireless transceiver, the UE may strive to coordinate the first C-DRX mode and the second C-DRX mode so that DRX ON times 402, 404 of the first and second C-DRX modes are staggered. In some cases, the DRX ON times 402, 404 may be adjacent (or close) in time, so that the UE may wake up, transmit or receive on one network, transmit or receive on the other network, and go back to sleep while conserving the greatest amount of power. To stagger the DRX ON times 402, 404 of the first and second C-DRX modes, the UE may have to request a particular DRX offset adjustment 406 or 408 from one or both of the first or second networks. Currently, there is no mechanism for a UE to do this.

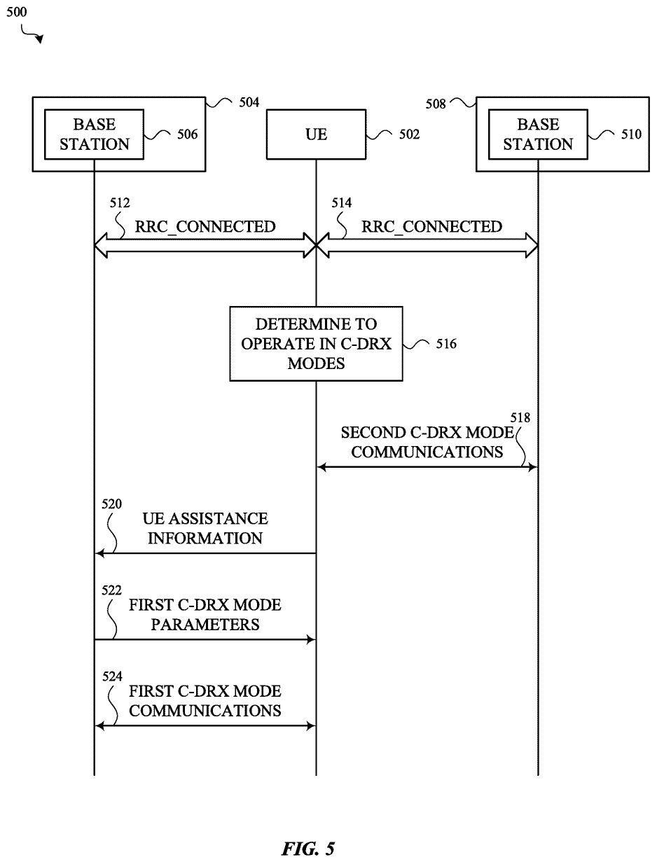

Since 3GPP Release 16 (Rel-16), a UE has been able to request the following parameters from a network, using UE assistance information: a preferred DRX long cycle (e.g., preferredDRX-LongCycle or preferredDRX-ShortCycle), a DRX inactivity timer (e.g., preferredDRX-Inactivity Timer), or a preferred DRX short cycle (e.g., preferredDRX-ShortCycleTimer). However, a UE has not been able to request a DRX offset adjustment (e.g., a preferred DRX slot offset). As a result, a UE may experience one of two suboptimal scenarios. The first suboptimal scenario is that a UE having a single wireless transceiver (e.g., a single Tx/Rx chain) may have the DRX ON durations for its C-DRX modes with different networks scheduled at the same time. Such a UE would be forced to miss its DRX ON duration with one of the networks. The second suboptimal scenario is that a UE having two or more wireless transceivers (e.g., two or more Tx/Rx chains) may have the DRX ON durations for its C-DRX modes with different networks scheduled at different times. Such a UE would be forced to wake up twice, for the different DRX ON durations, even though it could wake up once and transmit or receive on both networks simultaneously. Solutions to reduce the likelihood that either of these suboptimal scenarios will occur are described with reference to FIGS. 5-9 and elsewhere herein.

FIG. 5 illustrates an example flow diagram 500 for configuring a C-DRX cycle. Various operations of the flow diagram are performed by a UE 502, a first network 504 (e.g., a first base station 506), or a second network 508 (e.g., a second base station 510). By way of example, the UE 502, first base station 506, and second base station 510 may be the UE, first base station, and second base station described with reference to FIG. 1.

At 512 and 514, the UE 502 may contemporaneously maintain a first RRC_CONNECTED state with the first network 504 and a second RRC_CONNECTED state with the second network 508.

At 516, the UE 502 may determine to operate in a first C-DRX mode with the first network 504 and a second C-DRX mode with the second network 508, while maintaining the first RRC_CONNECTED state and the second RRC CONNECTED state.

At 518, the UE 502 may communicate with the second network 508, establish parameters for operating in the second C-DRX mode, and begin operating in the second C-DRX mode with the second network 508.

At 520, the UE 502 may transmit UE assistance information to the first network 504. In some embodiments, the UE assistance information may include DRX parameters requested by the UE 502 to coordinate the first C-DRX mode with the second C-DRX mode. These embodiments may be referred to herein as UE-controlled embodiments. In some embodiments, the UE assistance information may include parameters of the second C-DRX mode (e.g., a C-DRX configuration of the second C-DRX mode). These latter embodiments may be referred to herein as network-controlled embodiments.

At 522, the UE 502 may receive parameters of the first C-DRX mode (e.g., a C-DRX configuration of the first C-DRX mode) from the first network 504. The first C-DRX mode may or may not be coordinated with the second C-DRX mode, at the first network's discretion.

At 524, the UE 502 may begin operating in the first C-DRX mode with the first network 504.

In some embodiments of the flow diagram 500, the UE 502 may determine that the first C-DRX mode is not coordinated with the second C-DRX mode. In these embodiments, the UE may optionally repeat the operations at 520 and 522, but in the context of transmitting UE assistance information to the second network 508, to determine whether the second network 508 will coordinate the second C-DRX mode with the first C-DRX mode.

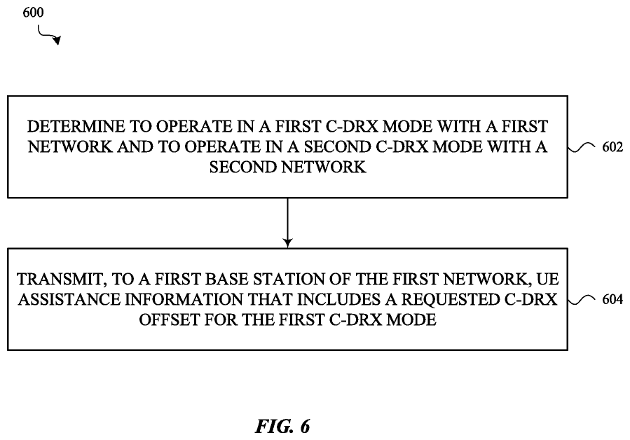

FIG. 6 shows a first example method 600 of wireless communication by a UE. The method 600 may be performed by a processor of the UE, and the UE may communicate with a first network or a second network via one or more wireless transceivers of the UE. In some embodiments, the UE may be a UE described with reference to any of FIGS. 1, 3, 4, 5, 10, or 11.

At 602, the UE may determine to operate in a first C-DRX mode with a first network and to operate in a second C-DRX mode with a second network.

At 604, the UE may transmit, to a first base station of the first network and via a wireless transceiver of the UE, UE assistance information that includes a requested C-DRX offset for the first C-DRX mode. The C-DRX offset may include at least one of a long cycle DRX start offset or a DRX slot offset. The UE assistance information may also include a requested upper bound of an inactivity timer for the first C-DRX mode, or other requested parameters for the first C-DRX mode.

In some embodiments of the method 600, the UE may maintain a first RRC_CONNECTED state with the first network and, contemporaneously with the maintenance of the first RRC_CONNECTED state, maintain a second RRC_CONNECTED state with the second network. When such a UE is receiving and/or transmitting traffic from/to the first and second networks, but one or more conditions are met, the UE may determine to operate in the first C-DRX mode and the second C-DRX mode while maintaining the first RRC_CONNECTED state and the second RRC_CONNECTED state. The one or more conditions may include, for example, a determination that the UE's battery power is below a threshold level, or a determination that the traffic from/to the first and second networks is infrequent.

Upon determining to operate in the first C-DRX mode and the second C-DRX mode, the UE may strive to coordinate the first C-DRX mode and the second C-DRX mode. The coordination may be based on the UE's capabilities. For example, if the UE only has a single wireless transceiver (e.g., a single Tx/Rx chain), or if the UE intends to maintain the first RRC CONNECTED state and the second RRC_CONNECTED state via only a single wireless transceiver, then the UE may strive to stagger a first C-DRX ON time of the first C-DRX mode with respect to a second C-DRX ON time of the second C-DRX mode. To do this, the UE may request a C-DRX offset and/or other parameters for the first C-DRX mode, at 604, such that the parameters would result in a staggering of the first C-DRX ON time and the second C-DRX ON time.

As another example of C-DRX mode coordination, if the UE has two or more wireless transceivers (e.g., two or more Tx/Rx chains) and intends to maintain the first RRC_CONNECTED state and the second RRC_CONNECTED state via different wireless transceivers (e.g., via a first wireless transceiver for the first RRC CONNECTED state and a second wireless transceiver for the second RRC_CONNECTED state), then the UE may strive to overlap the first C-DRX ON time of the first C-DRX mode with respect to the second C-DRX ON time of the second C-DRX mode. To do this, the UE may request a C-DRX offset and/or other parameters for the first C-DRX mode, at 604, such that the parameters would result in an overlap, and in some cases an alignment of, the first C-DRX ON time and the second C-DRX ON time. An alignment of the first C-DRX ON time and the second C-DRX ON time may include a same start time of the C-DRX ON times and, in some cases, a same end time of the C-DRX ON times (assuming that neither ON time is extended as a result of traffic to be received or transmitted).

In some embodiments of the method 600, the first network may not configure the first C-DRX mode with the requested C-DRX offset and/or other parameters requested by the UE. In these embodiments, the UE may determine the requested C-DRX offset for the first C-DRX mode has not been granted and transmit, to a second base station of the second network, second UE assistance information that includes a second requested C-DRX offset for the second C-DRX mode.

In some cases, a requested C-DRX offset may be indicated by means of a particular value. In other cases, a requested C-DRX offset may be indicated by means of an index into a codebook of C-DRX offset values (i.e., a set of predetermined C-DRX offset values indicated in a specification, or a set of possible C-DRX offset values provided to the UE by a network).

In some embodiments of the method 600, the UE may additionally or alternatively determine the C-DRX offset (e.g., a value of the C-DRX offset), or other requested parameters for the first C-DRX mode or the second C-DRX mode, based on factors other than the number of wireless transceivers the UE has (or the number of wireless transceivers that the UE will use for communication with the first and second networks). For example, the UE may determine a band combination (i.e., a combination of frequency bands) that will be used to communicate with the first network and the second network in the first C-DRX mode and the second C-DRX mode, and additionally or alternatively determine the requested C-DRX offset based, at least in part, on whether a same wireless receiver or different wireless receivers will be used for the band combination. This factor is useful in that the UE may support simultaneous communication on different networks with some band combinations, but not others.

In some embodiments of the method 600, the UE may determine a first time domain duplexing (TDD) configuration of the first network and a second TDD configuration of the second network, and additionally or alternatively determine the requested C-DRX offset based, at least in part, on the first TDD and the second TDD.

In some embodiments of the method 600, the UE may determine a first expected traffic flow with the first network and a second expected traffic flow with the second network, and additionally or alternatively determine the requested C-DRX offset based, at least in part, on the first expected traffic flow and the second expected traffic flow.

Because the UE starts or restarts an inactivity timer every time a PDCCH indicates a subsequent arrival of a new UL or DL transmission for the UE, it is possible that a network may extend the UE's ON duration for the first or second C-DRX mode, such that a single C-DRX mode consumes the majority or entirety of a DRX cycle and leaves no opportunity for the UE to enter its C-DRX ON duration for another network. The likelihood of such a scenario occurring may be mitigated if the UE requests an upper bound of an inactivity timer for the first and/or second C-DRX mode.

The method 600 may be variously embodied, extended, or adapted, as described with reference to FIGS. 1 and 3-5 and elsewhere in this description.

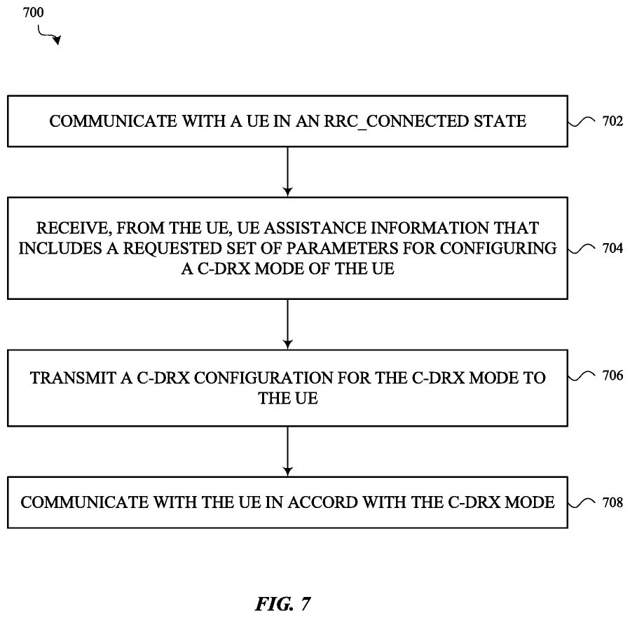

FIG. 7 shows a first example method 700 of wireless communication by a base station. The method 700 may be performed by a processor of the base station, and the base station may communicate with one or more UEs via one or more wireless transceivers of the base station. In some embodiments, the base station may be a base station described with reference to any of FIGS. 1, 3, 4, 5, 10, or 11.

At 702, the base station may communicate with a UE in an RRC CONNECTED state.

At 704, the base station may receive, from the UE, UE assistance information that includes a requested set of parameters for configuring a C-DRX mode of the UE.

At 706, the base station may transmit a C-DRX configuration for the C-DRX mode to the UE. The C-DRX configuration may or may not use the requested set of parameters.

At 708, the base station may communicate with the UE in accord with the C-DRX mode.

The method 700 may be variously embodied, extended, or adapted, as described with reference to FIGS. 1 and 3-5 and elsewhere in this description.

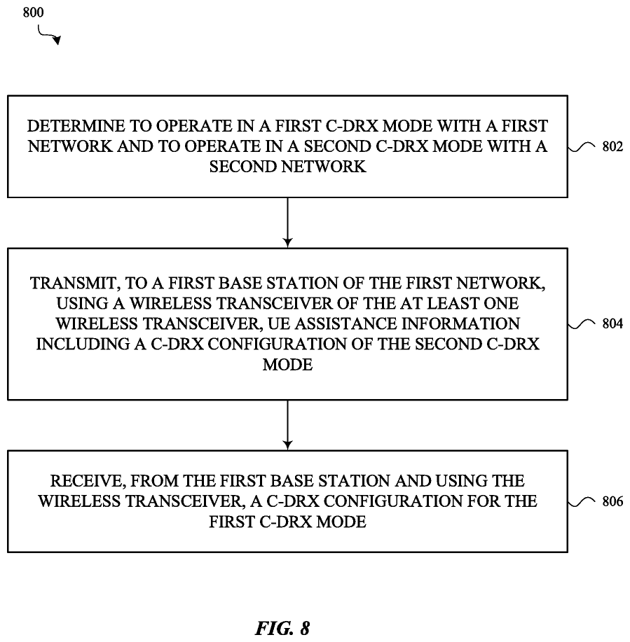

FIG. 8 shows a second example method 800 of wireless communication by a UE. The method 800 may be performed by a processor of the UE, and the UE may communicate with a first network or a second network via one or more wireless transceivers of the UE. In some embodiments, the UE may be a UE described with reference to any of FIGS. 1, 3, 4, 5, 10, or 11.

At 802, the UE may determine to operate in a first C-DRX mode with a first network and to operate in a second C-DRX mode with a second network.

At 804, the UE may transmit, to a first base station of the first network and via a wireless transceiver of the UE, UE assistance information that includes a C-DRX configuration of the second C-DRX mode (e.g., a DRX-Config information element (IE) for the second C-DRX mode).

At 806, the UE may receive, from the first base station and via the wireless transceiver, a C-DRX configuration for the first C-DRX mode.

In some embodiments of the method 800, the UE assistance information may further include, for example, an indication of whether the UE can allocate one wireless transceiver or more than one wireless transceiver for communication with the first network when operating in the first C-DRX mode. The UE assistance information may also include one or more of: an indication of a TDD configuration of the second network (e.g., a TDD-UL-DL-ConfigCommon IE), an indication of an expected traffic flow with the second network (e.g., an indication of UL or DL traffic patterns), or an indication of whether the first network and the second network are synchronized. The latter indication may include, for example, a system frame number (SFN) offset between the first network and the second network and/or a slot offset between the first network and the second network.

The method 800 may be variously embodied, extended, or adapted, as described with reference to FIGS. 1 and 3-5 and elsewhere in this description.

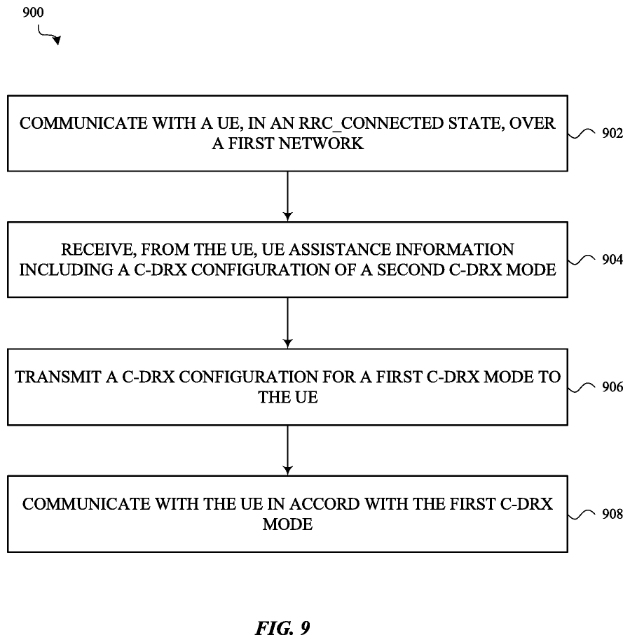

FIG. 9 shows a second example method 900 of wireless communication by a base station. The method 900 may be performed by a processor of the base station, and the base station may communicate with one or more UEs via one or more wireless transceivers of the base station. In some embodiments, the base station may be a base station described with reference to any of FIGS. 1, 3, 4, 5, 10, or 11.

At 902, the base station may communicate with a UE, in an RRC_CONNECTED state, over a first network. The base station may be a first base station of the first network.

At 904, the base station may receive, from the UE, UE assistance information that includes a C-DRX configuration of a second C-DRX mode (e.g., a DRX-Config information element (IE) for a second C-DRX mode that the UE uses for communication with a second base station over a second network).

At 906, the base station may transmit a C-DRX configuration for a first C-DRX mode to the UE. The C-DRX configuration may or may not coordinate the first C-DRX mode with the second C-DRX mode.

At 908, the base station may communicate with the UE in accord with the first C-DRX mode.

The method 900 may be variously embodied, extended, or adapted, as described with reference to FIGS. 1 and 3-5 and elsewhere in this description.

Embodiments contemplated herein include an apparatus having means to perform one or more elements of the method 600, 700, 800, or 900. In the context of method 600 or 800, the apparatus may be, for example, an apparatus of a UE (such as a wireless device 1102 that is a UE, as described herein). In the context of method 700 or 900, the apparatus may be, for example, an apparatus of a base station (such as a network device 1120 that is a base station, as described herein).

Embodiments contemplated herein include one or more non-transitory computer-readable media storing instructions to cause an electronic device, upon execution of the instructions by one or more processors of the electronic device, to perform one or more elements of the method 600, 700, 800, or 900. In the context of method 600 or 800, the non-transitory computer-readable media may be, for example, a memory of a UE (such as a memory 1106 of a wireless device 1102 that is a UE, as described herein). In the context of method 700 or 900, the non-transitory computer-readable media may be, for example, a memory of a base station (such as a memory 1124 of a network device 1120 that is a base station, as described herein).

Embodiments contemplated herein include an apparatus having logic, modules, or circuitry to perform one or more elements of the method 600, 700, 800, or 900. In the context of method 600 or 800, the apparatus may be, for example, an apparatus of a UE (such as a wireless device 1102 that is a UE, as described herein). In the context of method 700 or 900, the apparatus may be, for example, an apparatus of a base station (such as a network device 1120 that is a base station, as described herein).

Embodiments contemplated herein include an apparatus having one or more processors and one or more computer-readable media, using or storing instructions that, when executed by the one or more processors, cause the one or more processors to perform one or more elements of the method 600, 700, 800, or 900. In the context of method 600 or 800, the apparatus may be, for example, an apparatus of a UE (such as a wireless device 1102 that is a UE, as described herein). In the context of the method 700 or 900, the apparatus may be, for example, an apparatus of a base station (such as a network device 1120 that is a base station, as described herein).

Embodiments contemplated herein include a signal as described in or related to one or more elements of the method 600, 700, 800, or 900.

Embodiments contemplated herein include a computer program or computer program product having instructions, wherein execution of the program by a processor causes the processor to carry out one or more elements of the method 600, 700, 800, or 900. In the context of method 600 or 800, the processor may be a processor of a UE (such as a processor(s) 1104 of a wireless device 1102 that is a UE, as described herein), and the instructions may be, for example, located in the processor and/or on a memory of the UE (such as a memory 1106 of a wireless device 1102 that is a UE, as described herein). In the context of method 700 or 900, the processor may be a processor of a base station (such as a processor(s) 1122 of a network device 1120 that is a base station, as described herein), and the instructions may be, for example, located in the processor and/or on a memory of the base station (such as a memory 1124 of a network device 1120 that is a base station, as described herein).

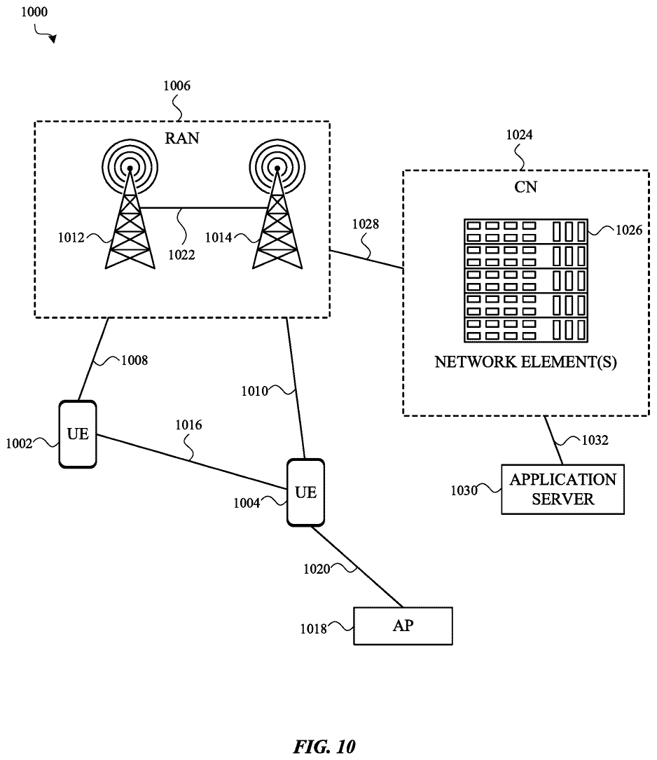

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication. In some embodiments, one or both of the UEs 1002, 1004 may be a MUSIM UE.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations, such as base station 1012 and base station 1014, that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

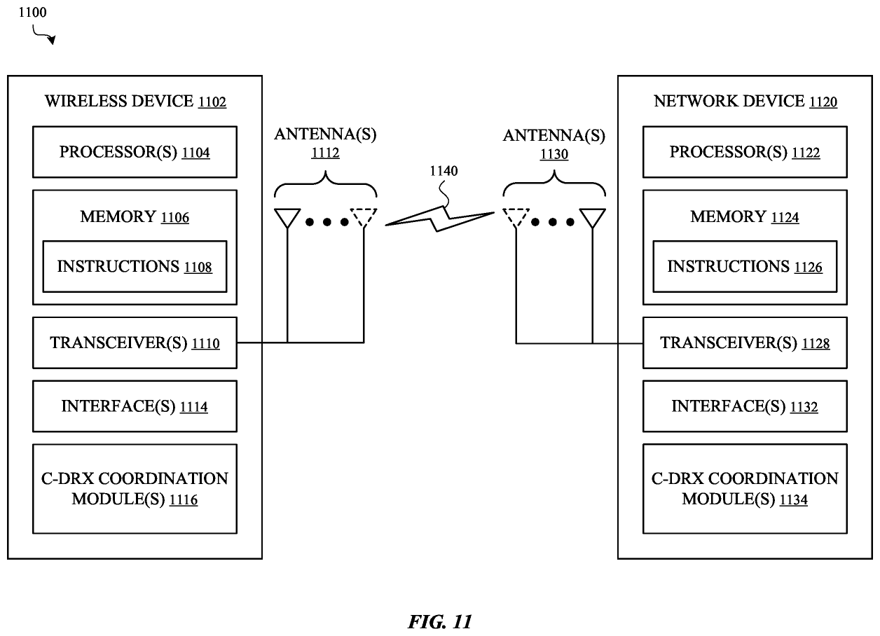

FIG. 11 illustrates a system 1100 for performing signaling 1140 between a wireless device 1102 and a network device 1120, according to embodiments disclosed herein. The system 1100 may be a portion of a wireless communication system as herein described. The wireless device 1102 may be, for example, a UE of a wireless communication system. In some embodiments, the wireless device 1102 may be a MUSIM UE. The network device 1120 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter and/or receiver circuitry that use the antenna(s) 1112 of the wireless device 1102 to facilitate signaling (e.g., the signaling 1140) to and/or from the wireless device 1102 with other devices (e.g., the network device 1120) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include one or more C-DRX coordination module(s) 1116. The C-DRX coordination module(s) 1116 may be implemented via hardware, software, or combinations thereof. For example, the C-DRX coordination module(s) 1116 may be implemented as a processor, circuit, and/or instructions 1108 stored in the memory 1106 and executed by the processor(s) 1104. In some examples, the C-DRX coordination module(s) 1116 may be integrated within the processor(s) 1104 and/or the transceiver(s) 1110. For example, the C-DRX coordination module(s) 1116 may be implemented by a combination of software components (e.g., executed by a DSP or a general processor) and hardware components (e.g., logic gates and circuitry) within the processor(s) 1104 or the transceiver(s) 1110.

The C-DRX coordination module(s) 1116 may be used for various aspects of the present disclosure, for example, aspects of FIGS. 1-9. The C-DRX coordination module(s) 1116 may be configured, for example, to transmit to another device (e.g., the network device 1120), requested C-DRX parameters for a first C-DRX mode of the wireless device 1102 (e.g., a C-DRX mode with the other device). The other device (e.g., the network device 1120) may consider the requested C-DRX parameters when configuring the first C-DRX mode. The requested C-DRX parameters may provide coordination of the first C-DRX mode with a second C-DRX mode. The second C-DRX mode may be used by the wireless device 1102 to communicate with a network device of another network. Alternatively, the C-DRX coordination module(s) 1116 may be configured, for example, to transmit a configuration of the second C-DRX mode to the other device (e.g., the network device 1120), so that the other device may consider the configuration of the second C-DRX mode when configuring the first C-DRX mode for the wireless device 1102.

The network device 1120 may include one or more processor(s) 1122. The processor(s) 1122 may execute instructions such that various operations of the network device 1120 are performed, as described herein. The processor(s) 1104 may include one or more baseband processors implemented using, for example, a CPU, a DSP, an ASIC, a controller, an FPGA device, another hardware device, a firmware device, or any combination thereof configured to perform the operations described herein.

The network device 1120 may include a memory 1124. The memory 1124 may be a non-transitory computer-readable storage medium that stores instructions 1126 (which may include, for example, the instructions being executed by the processor(s) 1122). The instructions 1126 may also be referred to as program code or a computer program. The memory 1124 may also store data used by, and results computed by, the processor(s) 1122.

The network device 1120 may include one or more transceiver(s) 1128 that may include RF transmitter and/or receiver circuitry that use the antenna(s) 1130 of the network device 1120 to facilitate signaling (e.g., the signaling 1140) to and/or from the network device 1120 with other devices (e.g., the wireless device 1102) according to corresponding RATs.

The network device 1120 may include one or more antenna(s) 1130 (e.g., one, two, four, or more). In embodiments having multiple antenna(s) 1130, the network device 1120 may perform MIMO, digital beamforming, analog beamforming, beam steering, etc., as has been described.

The network device 1120 may include one or more interface(s) 1132. The interface(s) 1132 may be used to provide input to or output from the network device 1120. For example, a network device 1120 that is a base station may include interface(s) 1132 made up of transmitters, receivers, and other circuitry (e.g., other than the transceiver(s) 1128/antenna(s) 1130 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1120 may include one or more C-DRX coordination module(s) 1134. The C-DRX coordination module(s) 1134 may be implemented via hardware, software, or combinations thereof. For example, the C-DRX coordination module(s) 1134 may be implemented as a processor, circuit, and/or instructions 1126 stored in the memory 1124 and executed by the processor(s) 1122. In some examples, the C-DRX coordination module(s) 1134 may be integrated within the processor(s) 1122 and/or the transceiver(s) 1128. For example, the C-DRX coordination module(s) 1134 may be implemented by a combination of software components (e.g., executed by a DSP or a general processor) and hardware components (e.g., logic gates and circuitry) within the processor(s) 1122 or the transceiver(s) 1128.

The C-DRX coordination module(s) 1134 may be used for various aspects of the present disclosure, for example, aspects of FIGS. 1-9. The C-DRX coordination module(s) 1134 may be configured, for example, to receive requested C-DRX parameters from another device (e.g., the wireless device 1102) and consider the requested C-DRX parameters when configuring a C-DRX mode with the other device. Alternatively, the C-DRX coordination module(s) 1134 may be configured to, for example, receive a configuration of a C-DRX mode that another device (e.g., the wireless device 1102) operates in with another network, and consider the configuration of the C-DRX mode with the other network when configuring a C-DRX mode with the other device.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
determine to operate in a first C-DRX mode with a first network and to operate in a second C-DRX mode with a second network; and
generate, for transmission, UE assistance information that includes a requested C-DRX offset for the first C-DRX mode, the requested C-DRX offset to stagger a first C-DRX ON time of the first C-DRX mode with respect to a second C-DRX ON time of the second C-DRX mode.

2. The apparatus of claim 1, wherein the requested C-DRX offset comprises at least one of a long cycle DRX start offset or a DRX slot offset.

3. The apparatus of claim 1, wherein
the processor is configured to:
maintain, a first RRC_CONNECTED state with the first network;
contemporaneously with the maintenance of the first RRC_CONNECTED state, maintain a second RRC_CONNECTED state with the second network; and
determine to operate in the first C-DRX mode and the second C-DRX mode while maintaining the first RRC_CONNECTED state and the second RRC_CONNECTED state.

4. The apparatus of claim 3, wherein:
the processor is configured to maintain the second RRC_CONNECTED state with the second network.

5. The apparatus of claim 3, wherein:
the processor is configured to maintain the second RRC_CONNECTED state with the second network; and
the requested C-DRX offset for the first C-DRX mode is requested to overlap a first C-DRX ON time of the first C-DRX mode and a second C-DRX ON time of the second C-DRX mode.

6. The apparatus of claim 5, wherein the requested C-DRX offset for the first C-DRX mode is requested to align the first C-DRX ON time with respect to the second C-DRX ON time.

7. The apparatus of claim 1, wherein
the processor is configured to:
determine the requested C-DRX offset for the first C-DRX mode is not granted; and
generate, for transmission, second UE assistance information that includes a second requested C-DRX offset for the second C-DRX mode.

8. The apparatus of claim 1, wherein
the processor is configured to:
determine a band combination that will be used to communicate with the first network and the second network in the first C-DRX mode and the second C-DRX mode; and
determine the requested C-DRX offset based, at least in part, on whether a same wireless receiver or different wireless receivers will be used for the band combination.

9. The apparatus of claim 1, wherein
the processor is configured to:
determine a first time domain duplexing (TDD) configuration of the first network and a second TDD configuration of the second network; and
determine the requested C-DRX offset based, at least in part, on the first TDD and the second TDD.

10. The apparatus of claim 1, wherein
the processor is configured to:
determine a first expected traffic flow with the first network and a second expected traffic flow with the second network; and
determine the requested C-DRX offset based, at least in part, on the first expected traffic flow and the second expected traffic flow.

11. The apparatus of claim 1, wherein the processor is configured to generate, for transmission in the UE assistance information, a requested upper bound of an inactivity timer for the first C-DRX mode.

12. The apparatus of claim 1, wherein the requested C-DRX offset for the first C-DRX mode is indicated by an index into a codebook of C-DRX offset values.

13. An apparatus comprising memory coupled to a processor, the processor configured to:
determine to operate in a first C-DRX mode with a first network and to operate in a second C-DRX mode with a second network;
generate, for transmission, UE assistance information that includes a C-DRX configuration of the second C-DRX mode; and
receive, from the first network, a C-DRX configuration for the first C-DRX mode.

14. The apparatus of claim 13, wherein the processor is configured to include, in the UE assistance information, an indication of whether a UE including the apparatus can allocate one wireless transceiver or more than one wireless transceive for communication with the first network when operating in the first C-DRX mode.

15. The apparatus of claim 13, wherein the processor is configured to include, in the UE assistance information, an indication of a time domain duplexing (TDD) configuration of the second network.

16. The apparatus of claim 13, wherein the processor is configured to include, in the UE assistance information, an indication of an expected traffic flow with the second network.

17. The apparatus of claim 13, wherein the processor is configured to include, in the UE assistance information, an indication of whether the first network and the second network are synchronized.

18. The apparatus of claim 17, wherein the indication includes at least one of:
a system frame number (SFN) offset between the first network and the second network; or
a slot offset between the first network and the second network.

19. A method of a user equipment (UE), comprising:
maintaining a first RRC_CONNECTED state with a first network;
contemporaneously with the maintenance of the first RRC_CONNECTED state, maintaining a second RRC_CONNECTED state with a second network;
determining, while maintaining the first RRC_CONNECTED state and the second RRC_CONNECTED state, to operate in a first C-DRX mode with the first network and to operate in a second C-DRX mode with the second network; and
generating, for transmission and for the first C-DRX mode, UE assistance information that includes a set of requested C-DRX parameters, the set of requested C-DRX parameters including a requested C-DRX offset that staggers a first C-DRX ON time of the first C-DRX mode with respect to a second C-DRX ON time of the second C-DRX mode.

20. (canceled)
